(19) United States
(12) Patent Application Publication
(10) Pub. No.: US 2014/0368034 A1
(43) Pub. Date: Dec. 18, 2014

(54) POWER SUPPLY SYSTEM AND METHOD AND ELECTRONIC DEVICE THEREOF

(71) Applicant: Wistron Corporation, New Taipei City (TW)

(72) Inventors: Yuan-Tai Chen, New Taipei City (TW); Kai-Hou Lin, New Taipei City (TW); Shao-Huai Tsai, New Taipei City (TW); Kai-Yu Chu, New Taipei City (TW); Yu-Han Tsai, New Taipei City (TW)

(73) Assignee: Wistron Corporation, New Taiepei City (TW)

(21) Appl. No.: 14/034,579

(22) Filed: Sep. 24, 2013

(30) Foreign Application Priority Data
Jun. 17, 2013 (TW) 102121355

(51) Int. Cl. H02J 4/00

(52) U.S. Cl. CPC H02J 4/00
USPC 307/25

(57) ABSTRACT

A power supply system used in an electronic device includes a light absorption device, exposed to a backlight source of the electronic device, for absorbing backlight irradiated by the backlight source; an energy conversion circuit, coupled to the light absorption device, for converting the backlight irradiated by the backlight source into electrical power; and a power storage device, coupled to the energy conversion circuit, for storing the electrical power of the energy conversion circuit.

### BACKGROUND OF THE INVENTION

1. Field of the Invention

The present invention relates to a power supply system and method, and an electronic device thereof, and more particularly, to a power supply system and method and an electronic device thereof capable of converting a backlight of the electronic device into electrical power, in order to provide for operations of each element in the electronic device.

2. Description of the Prior Art

Due to advances in technology and industry, the use of portable electronic products in everyday life is becoming increasingly common. In order to facilitate the portability, a portable electronic device is equipped with a battery for storing electricity to provide operating power. The amount of electricity that can be stored in the battery is limited, however. In order to enhance the battery life for prolonging the usage time of the electronic product, a prior art solution utilizes a larger battery to enhance the battery capacity. Other solutions may involve reducing the performance of various elements of the portable device to prolong the usage time, such as reducing brightness of the display, using power save mode, etc.

An enlarged battery capacity may also result in an increase in size and weight of the electronic product, which may be considered undesirable by modern consumers. In addition, the reduction in various aspects of product performance may give consumers a poor impression.

### SUMMARY OF THE INVENTION

It is therefore an objective of the present invention to provide a power supply system and method, which is capable of converting a backlight of an electronic device into electrical power to be stored in the electronic device and provided for operations of each element in the electronic device, in order to enhance battery life of the electronic device.

An embodiment of the invention discloses a power supply system used in an electronic device. The power supply system comprises a light absorption device, exposed to a backlight source of the electronic device, for absorbing backlight irradiated by the backlight source; an energy conversion circuit, coupled to the light absorption device, for converting the backlight irradiated by the backlight source into electrical power; and a power storage device, coupled to the energy conversion circuit, for storing the electrical power of the energy conversion circuit.

An embodiment of the invention further discloses a power supply method for an electronic device. The power supply method comprises exposing a light absorption device to a backlight source of the electronic device for absorbing backlight irradiated by the backlight source; and converting the backlight irradiated by the backlight source into electrical power and storing the electrical power in a power storage device, in order to supply power to the electronic device.

An embodiment of the invention further discloses an electronic device. The electronic device comprises an operation circuit; a display module, comprising a screen and a backlight source, controlled by the operation circuit to display images; and a power supply system, for supplying power to the operation circuit and the display module. The power supply system comprises a light absorption device, exposed to the backlight source of the display module in the electronic device, for absorbing backlight irradiated by the backlight source; an energy conversion circuit, coupled to the light absorption device, for converting the backlight irradiated by the backlight source into electrical power; and a power storage device, coupled to the energy conversion circuit, for storing the electrical power of the energy conversion circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display module according to an embodiment of the invention.

FIG. 2 is a schematic diagram of the principle of the photoelectric converter converting light energy into electrical power.

FIG. 3 is a schematic diagram of an electronic device according to an embodiment of the invention.

### DETAILED DESCRIPTION

Prior art methods for enhancing battery life have certain disadvantages. Since many electronic devices possess a light source, in particular those electronic devices having a liquid crystal display (LCD), which usually have a backlight source that emits a backlight continuously (e.g. via cold cathode fluorescent lamp (CCFL), light emitting diode (LED), etc.), the present invention converts the energy of such backlight sources into electrical power on the premise that the display of the LCD will not be affected. The electrical power will then be stored in a battery or provided to the electronic device. When several devices use the electrical power converted from the light source, the consumption speed of the original system battery may be reduced, so that the battery life can be enhanced.

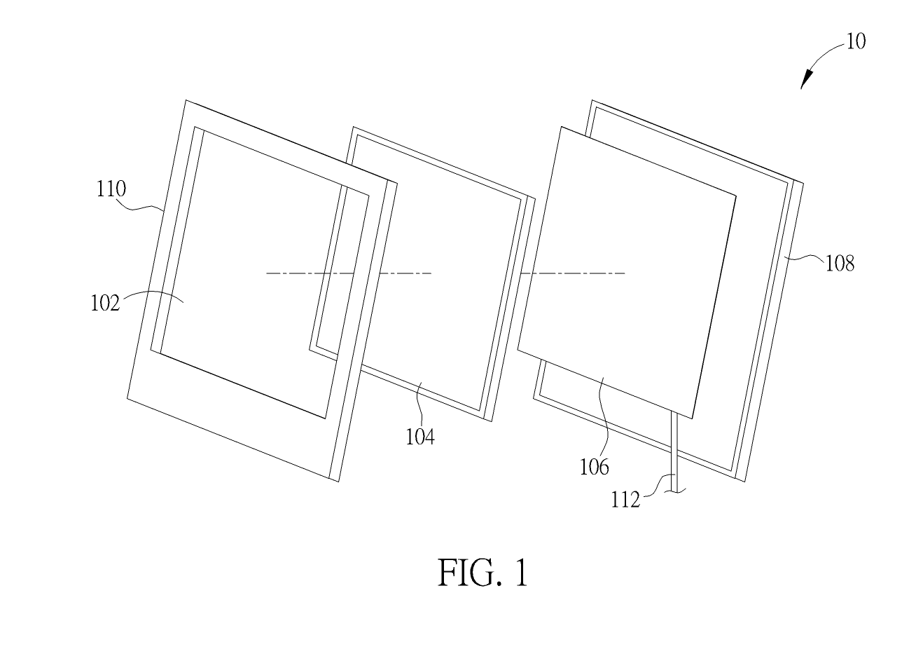

Please refer to FIG. 1, which is a schematic diagram of a display module 10 according to an embodiment of the invention. As shown in FIG. 1, the display module 10 includes a screen 102, a backlight source 104, a light absorption device 106, a back frame 108, a front cover 110 and a conducting wire 112. The display module 10 is an LCD, where the screen 102, the backlight source 104, the back frame 108 and the front cover 110 are common components of the LCD. The light absorption device 106 and the conducting wire 112 are further included in this structure according to the present invention. The light absorption device 106 may be disposed in a place exposed to the backlight source 104, in order to absorb backlight irradiated by the backlight source 104. In general, the light absorption device 106 has to be disposed at the back area or a side of the backlight source 104, in order to prevent an image display from being affected by the backlight source 104. The light absorption device 106 may be a photoelectric converter, in which electronics are stimulated to move when irradiated by the backlight source 104, in order to generate a current. The conducting wire 112 may transmit the current to be stored in a power storage device or it may be directly used by the electronic device.

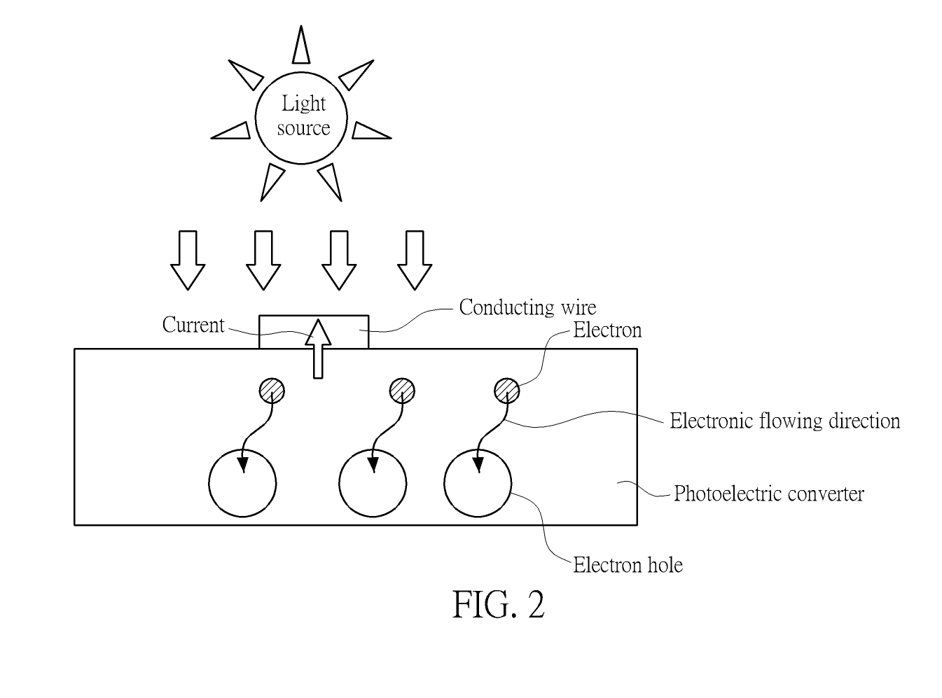

The principle of the photoelectric converter converting light energy into electrical power is illustrated in detail in FIG. 2. When the light irradiates the photoelectric converter, the electronics in the photoelectric converter may be stimulated by the light energy, so that the electronics are ionized to electron holes. A corresponding current may be generated in the direction opposite to the electronic flow, and such a current will be transmitted via a conducting wire. The photoelectric converter may be a silicon compound such as a single crystal silicon or poly-silicon. The photoelectric converter may also be a copper indium gallium selenide (CIGS) , photodiode or any other elements that can convert light energy into electrical power.

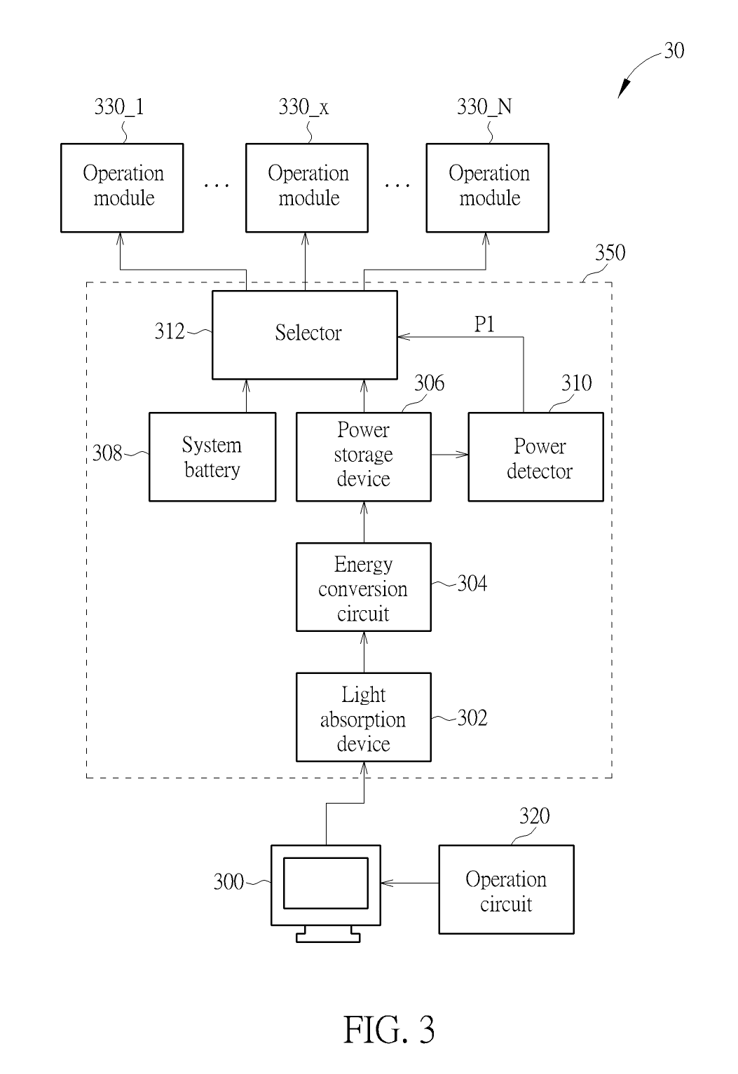

In a general electronic device, the power generated from the backlight source may not be enough for the whole electronic device; hence, the electronic device may still have another system battery charged via a power cord. As a result, an allocating mechanism should be applied in the electronic device to determine whether the system battery or the electrical power converted from the backlight is to be used as the power supply. Please refer to FIG. 3, which is a schematic diagram of an electronic device 30 according to an embodiment of the invention. As shown in FIG. 3, the electronic device 30 includes a display module 300, an operation circuit 320, operation modules 330_1-330_N and a power supply system 350. The structure of the display module 300 is similar to that of the display module 10, and also includes a screen and a backlight source and is controlled by the operation circuit 320 to display images. The operation modules 330_1-330_N, coupled to the power supply system 350, receive power supplied from the power supply system 350 for operations. The operation modules 330_1-330_N may be any elements or devices requiring power in the electronic device 30. In some embodiments, the operation circuit 320 may be one of the operation modules 330_1-330_N, or may be realized as a portion included in the operation modules 330_1-330_N, but is not limited herein.

Please keep referring to FIG. 3. The power supply system 350 includes a light absorption device 302, an energy conversion circuit 304, a power storage device 306, a system battery 308, a power detector 310 and a selector 312. The light absorption device 302, disposed in a place exposed to the backlight source corresponding to the display module 300 in the electronic device 30, is utilized for absorbing backlight irradiated by the backlight source. The energy conversion circuit 304, coupled to the light absorption device 302, is utilized for converting the backlight irradiated by the backlight source into electrical power. The power storage device 306, coupled to the energy conversion circuit 304, is utilized for storing the electrical power of the energy conversion circuit 304. The energy conversion circuit 304 includes a conducting wire, which is utilized for transmitting the currents converted from light emission of the light absorption device 302. The energy conversion circuit 304 may convert the energy into current or voltage form to be stored in the power storage device 306.

Since the electrical power generated from the backlight source may not be enough for the whole electronic device 30, the system battery 308 is further disposed in the electronic device 30. The system battery 308 may be any element having power storage functions, and may be utilized for storing and supplying power. The power detector 310, coupled to the power storage device 306, is utilized for detecting the electrical power stored in the power storage device 306, in order to output a power indication signal P1. The selector 312 may select to supply power via the power storage device 306 or the system battery 308 according to the power indication signal P1. Please note that the selector 312 may adjust the method of supplying power for the operation modules 330_1-330_N in many ways. For example, the selector 312 may individually control the power supply function of each operation module among the operation modules 330_1-330_N, i.e., among the operation modules 330_1-330_N, some operation modules may use power supplied from the power storage device 306, and other operation modules use power supplied from the system battery 308. The adjustment may be performed according to system requirements.

In an embodiment, the power supply method for an operation module 330_x may be controlled in the following way: setting a threshold value for the quantity of electrical power stored in the power storage device 306; when the quantity of electrical power is greater than the threshold value, the selector 312 selects to supply power via the power storage device 306; when the quantity of electrical power is less than the threshold value, the selector 312 selects to supply power via the system battery 308. As a result, since part of the operation modules 330_1-330_N use power converted from the backlight source, the consumption speed of the system battery 308 can be reduced, and the battery life can therefore increase.

In order to prevent the performance of the electronic device 30 from being affected due to the switching of the power source, the operation modules 330_1-330_N controlled by the selector 312 may be elements or devices which are not important in the electronic device 30. For example, if the electronic device 30 is a computer, the computer fan may be realized as one of the operation modules 330_1-330_N. For the operation modules 330_1-330_N, a small period of power-off may exist during the time when the power source is switched from the power storage device 306 to the system battery 308 or from the system battery 308 to the power storage device 306. If these less important elements or devices are set to be the operation modules 330_1-330_N, system performance may not be affected due to interruption of the operation modules 330_1-330_N when the power source switches. In addition, multiple threshold values may be utilized to control the switching time of power source in order to prevent the power source from being switched too frequently. For example, for any one of the operation modules 330_x, the power supply source is switched to be the power storage device 306 when the quantity of electrical power stored in the power storage device 306 is greater than 80%, and switched to be the system battery 308 when the quantity of electrical power stored in the power storage device 306 is less than 20%, which prevents the functions of the operation module 330_x from being affected by frequent switching of the power source.

It should be noted that, in the above embodiment, the backlight irradiated by the backlight source of the display module in the electronic device is converted into electrical power to be supplied. Those skilled in the art can make modifications and alterations accordingly. For example, the conversion efficiency of modern photoelectric converter is limited, and the backlight source which has a greater area should therefore be utilized for power conversion, in order to provide sufficient power. In other embodiments, however, any other elements or devices in the electronic device capable of emitting light may be utilized as the light source. In addition, the above operation module receiving power supplied via photoelectric conversion may be any elements or devices that need to use power in the electronic device. In other embodiments, the operation module may not be a part of the electronic device. For example, the electronic device may be implemented as a charging module, which charges an external device when the external device is connected to the electronic device. In addition, according to the above embodiments, those skilled in the art can use a proper power supply method for different types of electronic devices. For example, those skilled in the art may expose a light absorption device to a backlight source of the electronic device for absorbing backlight irradiated by the backlight source, and convert the backlight irradiated by the backlight source into electrical power and store the electrical power in a power storage device, in order to supply power to the electronic device. The variations or alterations related to such power supply method are illustrated above, and will not be narrated herein.

In the prior art, in order to enhance the battery life to prolong the usage time of an electronic product, a larger battery is utilized to enhance the battery capacity. Sometimes the products may also reduce the performance of various elements to prolong the usage time. This enlarged battery capacity may cause an increase in size and weight of the electronic product, however, which does not comply with the light and thin requirements of modern consumers. The reduction in product performance may also give a poor impression to consumers. In comparison, the present invention provides a power supply system and method, which is capable of converting a backlight of an electronic device into electrical power that is stored in the electronic device and provided for operations of each element in the electronic device. As a result, the battery life can be enhanced without affecting system performance and affecting the dimensions of the electronic product.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power supply system used in an electronic device comprising:
a light absorption device, exposed to a backlight source of the electronic device, for absorbing backlight irradiated by the backlight source;
an energy conversion circuit, coupled to the light absorption device, for converting the backlight irradiated by the backlight source into electrical power; and
a power storage device, coupled to the energy conversion circuit, for storing the electrical power of the energy conversion circuit.

2. The power supply system of claim 1, wherein the power supply system further comprises:
a system battery, for storing and supplying power;
a power detector, coupled to the power storage device, for detecting the electrical power stored in the power storage device, in order to output a power indication signal; and
a selector, for selecting to supply power via the power storage device or the system battery according to the power indication signal.

3. The power supply system of claim 2, wherein the selector selects to supply power via the power storage device when the power indication signal indicates that the electrical power stored in the power storage device is greater than a first threshold value.

4. The power supply system of claim 2, wherein the selector selects to supply power via the system battery when the power indication signal indicates that the electrical power stored in the power storage device is less than a second threshold value.

5. The power supply system of claim 1, wherein the light absorption device comprises a photoelectric converter, in which electronics are stimulated to move when irradiated by the backlight source, in order to generate a current.

6. The power supply system of claim 5, wherein the energy conversion circuit comprises a conducting wire, for transmitting the current to the power storage device.

7. A power supply method for an electronic device comprising:
exposing a light absorption device to a backlight source of the electronic device for absorbing backlight irradiated by the backlight source; and
converting the backlight irradiated by the backlight source into electrical power and storing the electrical power in a power storage device, in order to supply power to the electronic device.

8. The power supply method of claim 7, further comprising:
detecting the electrical power stored in the power storage device, in order to generate a power indication signal; and
selecting to supply power via the power storage device or a system battery according to the power indication signal.

9. The power supply method of claim 8, wherein the step of selecting to supply power via the power storage device or the system battery according to the power indication signal comprises selecting to supply power via the power storage device when the power indication signal indicates that the electrical power stored in the power storage device is greater than a first threshold value.

10. The power supply method of claim 8, wherein the step of selecting to supply power via the power storage device or the system battery according to the power indication signal comprises selecting to supply power via the system battery when the power indication signal indicates that the electrical power stored in the power storage device is less than a second threshold value.

11. The power supply method of claim 7, wherein the step of exposing the light absorption device to the backlight source of the electronic device for absorbing the backlight irradiated by the backlight source comprises:
utilizing a photoelectric converter as the light absorption device, in which electronics are stimulated to move when irradiated by the backlight source, in order to generate a current.

12. The power supply method of claim 11, further comprising transmitting the current to the power storage device.

13. An electronic device, comprising:
an operation circuit;
a display module, comprising a screen and a backlight source, controlled by the operation circuit to display images; and
a power supply system, for supplying power to the operation circuit and the display module, the power supply system comprising:
a light absorption device, exposed to the backlight source of the display module in the electronic device, for absorbing backlight irradiated by the backlight source;
an energy conversion circuit, coupled to the light absorption device, for converting the backlight irradiated by the backlight source into electrical power; and
a power storage device, coupled to the energy conversion circuit, for storing the electrical power of the energy conversion circuit.

14. The electronic device of claim 13, wherein the power supply system further comprises:
a system battery, for storing and supplying power;
a power detector, coupled to the power storage device, for detecting the electrical power stored in the power storage device, in order to output a power indication signal; and
a selector, for selecting to supply power via the power storage device or the system battery according to the power indication signal.

15. The electronic device of claim 14, wherein the selector selects to supply power via the power storage device when the power indication signal indicates that the electrical power stored in the power storage device is greater than a first threshold value.

16. The electronic device of claim 14, wherein the selector selects to supply power via the system battery when the power indication signal indicates that the electrical power stored in the power storage device is less than a second threshold value.

17. The electronic device of claim 13, wherein the light absorption device comprises a photoelectric converter, in which electronics are stimulated to move when irradiated by the backlight source, in order to generate a current.

18. The electronic device of claim 17, wherein the energy conversion circuit comprises a conducting wire, for transmitting the current to the power storage device.
